(19) United States
(12) Patent Application Publication
(10) Pub. No.: US 2024/0177296 A1
(43) Pub. Date: May 30, 2024

(54) INSPECTION APPARATUS, METHOD OF CONTROLLING THE SAME, AND STORAGE MEDIUM

(71) Applicant: CANON KABUSHIKI KAISHA, Tokyo (JP)

(72) Inventor: SHUNSUKE IWANO, Kanagawa (JP)

(21) Appl. No.: 18/511,022

(22) Filed: Nov. 16, 2023

(30) Foreign Application Priority Data
Nov. 22, 2022 (JP) 2022-186609

(51) Int. Cl. G06T 7/00; G06T 3/40; G06T 5/00; G06T 5/30; G06V 10/24

(52) U.S. Cl. CPC G06T 7/001; G06T 3/40; G06T 5/002; G06T 5/30; G06V 10/24; G06T 2207/30144

(57) ABSTRACT

An inspection apparatus for inspecting a target image that is obtained by reading an image formed on a recording medium by a printing apparatus. The inspection apparatus executes image simplifying processing for converting a plurality of image elements in image to a lump of image elements in which the plurality of image elements are concatenated, while maintaining positions of the image elements as-is, on a reference image and the target image, performs alignment between the reference image and the target image before subjected to the image simplifying processing, using moving related information regarding the alignment between the reference image and the target image based on the reference image and the target image that have been subjected to the image simplifying processing, and performs inspection by comparing the aligned reference image with the aligned target image.

### BACKGROUND OF THE INVENTION

### Field of the Invention

The present invention relates to an inspection apparatus, a method of controlling the same, and a storage medium.

### Description of the Related Art

In printed matter printed and output by a printing apparatus, stains may occur due to a coloring material such as ink or toner adhering to unintended areas. Alternatively, a coloring material may not sufficiently adhere to an area where an image is to be formed, resulting in color loss, i.e. the color appearing lighter than originally intended. Such stains and color loss, i.e. so-called image defects, degrade the quality of printed matter. It is therefore necessary to inspect printed matter for such defects and guarantee the quality of printed matter.

A visual inspection in which an inspector visually inspects an image for the presence of image defects requires a large amount of time and cost, and thus, inspection systems that automatically perform inspections without relying on visual inspection have been proposed in recent years. Such an inspection system that automatically performs inspections scans an image on printed matter with a scanner to obtain a scanned image, and performs an inspection by comparing the scanned image (target image to be inspected) with a reference image. When inspecting an image by comparing images in this manner, the alignment of the images greatly affects the inspection accuracy. Thus, it is important to increase the accuracy of alignment.

Typical known alignment includes extracting feature points of images and performing alignment using rigid-body alignment such as projective transformation. For example, in Japanese Patent Laid-open No. 2020-118497, alignment is performed by setting alignment areas at a leading edge and a trailing edge of an image in a conveyance direction, extracting feature points of each of these alignment areas, and detecting a shift amount based on the extracted features.

However, the aforementioned alignment using rigid-body transformation based on feature points cannot deal with local misalignment caused by conveying unevenness or paper stretching. Meanwhile, non-rigid-body alignment, such as free-form deformations (FFD), is known as a more accurate alignment method. This non-rigid-body alignment enables alignment in the case of an image shift and rotation can be performed as well as alignment in the case of localized scaling and misalignment. Thus employing free-form deformations enables more accurate alignment than alignment using rigid-body transformation.

With the free-form deformations, control points for controlling the shape of an image are arranged in a grid-like pattern on the image, and the image is deformed by moving the control points one by one. Then, to obtain a layout of the control points for performing deformation so that the target image to be inspected is aligned with the reference image, errors in the images are calculated and the positions of the control points are successively updated in a direction so that the errors are reduced.

If similar patterns exist in the vicinity when sequentially updating the positions of the control point as mentioned above, alignment may be performed on those similar patterns, and alignment accuracy may decrease. As a result, obtained inspection results may not be as expected.

### SUMMARY OF THE INVENTION

Embodiments of the present disclosure eliminate the above-mentioned issues with conventional technology.

A feature of embodiments of the present disclosure is to provide a technique capable of preventing a decrease in alignment accuracy even when similar and nearby patterns exist in an image.

According to embodiments of the present disclosure, there is provided an inspection apparatus for inspecting a target image to be inspected that is obtained by reading an image formed on a recording medium by a printing apparatus, the inspection apparatus comprising one or more controllers including one or more processors and one or more memories, the one or more controllers configured to: execute image simplifying processing for converting a plurality of image elements in image to a lump of image elements in which the plurality of image elements are concatenated, while maintaining positions of the image elements as-is, on a reference image and the target image to be inspected; perform alignment between the reference image and the target image to be inspected before subjected to the image simplifying processing, using moving related information regarding the alignment between the reference image and the target image to be inspected based on the reference image and the target image to be inspected that have been subjected to the image simplifying processing; and perform inspection by comparing the aligned reference image with the aligned target image to be inspected.

According to embodiments of the present disclosure, there is provided a method of controlling an inspection apparatus for inspecting a target image to be inspected that is obtained by reading an image formed on a recording medium by a printing apparatus, the method comprising: executing image simplifying processing for converting a plurality of image elements in image to a lump of image elements in which the plurality of image elements are concatenated, while maintaining positions of the image elements as-is, on a reference image and the target image to be inspected; performing alignment between the reference image and the target image to be inspected before subjected to the image simplifying processing, using moving related information regarding the alignment between the reference image and the target image to be inspected based on the reference image and the target image to be inspected that have been subjected to the image simplifying processing; and performing inspection by comparing the aligned reference image with the aligned target image to be inspected.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram for describing a configuration example of an entire printing system for outputting printed matter and performing inspections, including an image processing apparatus according to a first example of the present invention.

FIG. 2 is a functional block diagram for describing the functions of the image processing apparatus according to the first example.

FIG. 3 is a flowchart for describing inspection processing performed by the image processing apparatus according to the first example.

FIG. 4 is a flowchart for describing inspection processing in step S305 according to the first example.

FIGS. 5A and 5B depict views showing examples of filters used in filter processing in step S403 according to the first example.

FIG. 6 is a flowchart for describing alignment processing for aligning a reference image with an inspection target in step S401.

FIGS. 7A to 7C are diagrams for describing processing for aligning a target image to be inspected I with a reference image T according to the first example.

FIGS. 8A to 8D are schematic diagrams for describing alignment processing according to the first example.

FIGS. 9A to 9C are diagrams showing examples of coefficients of averaging filters according to the first example.

FIG. 10 is a diagram showing an example of a screen displaying inspection results according to the first example.

FIG. 11 is a flowchart for describing alignment processing for aligning a reference image with a target image to be inspected in step S401 in FIG. 4 according to a second example.

FIGS. 12A to 12D are diagrams showing examples of target images to be inspected when the filter size used is changed in correspondence with the number of updates in the second example.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### FIRST EXAMPLE

Hereinafter, the first example of the present invention will be described.

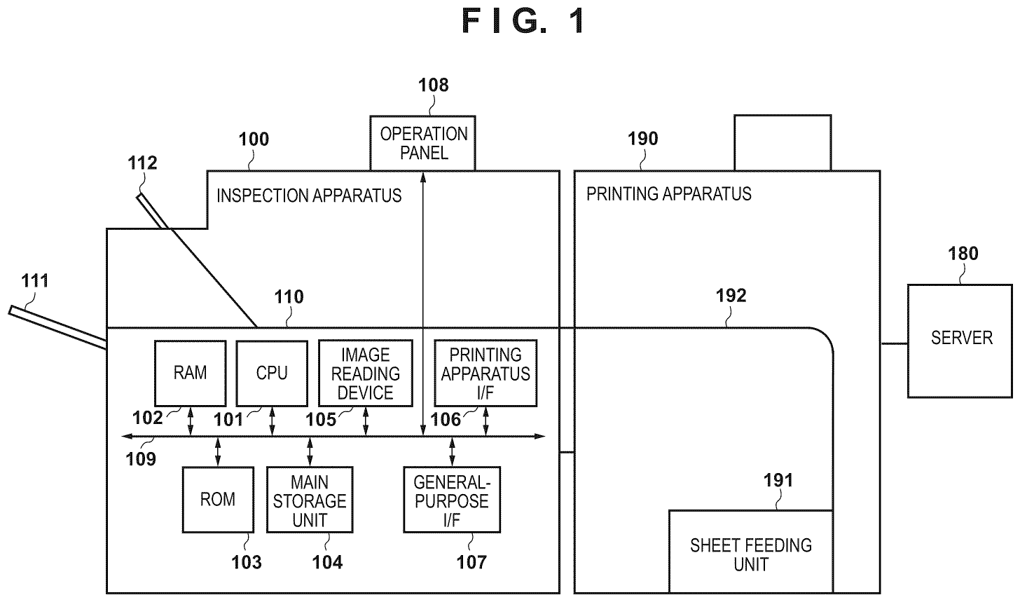

FIG. 1 is a diagram for describing a configuration example of an entire printing system for outputting printed matter and performing inspections. The printing system includes an image processing apparatus (inspection apparatus) 100 according to the first example of the present invention.

This printing system at least includes the image processing apparatus 100, a print server (hereinafter, “server”) 180, and a printing apparatus 190. The server 180 has functions of generating print jobs for originals to be printed and supplying the print jobs to the printing apparatus 190. The server 180 is communicatively connected to a plurality of external apparatuses (not shown) via a network. The server 180 may receive requests to generate print jobs and print data from the external apparatuses.

The printing apparatus 190 forms (prints) an image on a sheet (which is also referred to as a recording medium etc.) based on a print job supplied from the server 180. The printing apparatus 190 may be of an offset printing method, an electro-photographic method, an ink jet method, or the like. In the description of the first example, an electro-photographic printing apparatus is envisioned, but no such limitation on the present invention is intended. The printing apparatus 190 includes a sheet feeding unit 191, and a user sets sheets in the sheet feeding unit 191 in advance. When a print job is supplied to the printing apparatus 190, a sheet set in the sheet feeding unit 191 is conveyed along a conveyance path 192, an image is formed on the front surface or both surfaces of the sheet, and then the sheet with the image formed is conveyed to the image processing apparatus 100.

The image processing apparatus 100 executes inspection processing to check for image defects on the sheet with the image formed by the printing apparatus 190 that has been conveyed along the conveyance path 192, i.e. the printed matter. In other words, the image processing apparatus 100 functions as an inspection apparatus. Note that here, the overall processing for checking for image defects may be referred to as inspection processing, and processing included in the inspection processing for detecting each of different types of image defects may be referred to as defect inspection processing (or simply as “detection processing”).

The image processing apparatus 100 includes a CPU 101, a RAM 102, a ROM 103, a main storage unit 104, and an image reading device 105. The image processing apparatus 100 also includes an interface (I/F) 106 with the printing apparatus 190, a general-purpose interface (I/F) 107, a user interface (UI) panel (operation panel) 108, a main bus 109. Furthermore, the image processing apparatus 100 includes a conveyance path 110 for printed matter that is connected to the conveyance path 192 in the printing apparatus 190, an output tray 111 where printed matter that has passed inspection is discharged, and an output tray 112 where printed matter that has failed inspection due to a defect being found is discharged. Note that the printed matter may be classified into more detailed categories rather than just the two categories of passing and failing inspection.

The CPU 101 is a processor that controls the entire image processing apparatus 100. The RAM 102 functions as a main memory, a working area, and the like of the CPU 101. The ROM 103 stores program groups to be executed by the CPU 101. The main storage unit 104 stores applications to be executed by the CPU 101, data to be used in image processing, and the like. The image reading device (scanner) 105 can read images on one surface or both surfaces of the printed matter conveyed from the printing apparatus 190 on the conveyance path 110 and obtain scanned image data. Specifically, the image reading device 105 uses at least one reading sensor provided in the vicinity of the conveyance path 110 to read images on one surface or both surfaces of the conveyed printed matter. The reading sensor may be provided on the side of one surface side of the conveyed printed matter, or may be provided on both sides, namely the front and back surface sides of the conveyed printed matter in order to simultaneously read images on both surfaces. When the reading sensor is provided only on one surface side, the other surface of a printed matter may be read by the reading sensor by using a double-side conveyance path (not shown) in the conveyance path 110 to invert the front and the back of the printed matter after the first surface is read.

The printing apparatus I/F 106 is connected to the printing apparatus 190 and can synchronize the timing of processing for printed matter and share the operation status with the printing apparatus 190. The general-purpose I/F 107 is a serial bus interface such as USB or IEEE 1394, and the user can remove data such as logs and introduce data into the image processing apparatus 100 via this general-purpose I/F 107. The operation panel 108 includes, for example, a display (display unit) and various hardware keys, and functions as a user interface of the image processing apparatus 100 to communicate the current status and settings to the user by displaying these items. The display may have a touch-screen function and be configured to receive an instruction from the user in response to the user operating a displayed button.

The main bus 109 connects the components of the image processing apparatus 100. The internal components of the image processing apparatus 100 and the printing system can be made to operate via instructions from the CPU 101 given via the main bus 109. For example, the conveyance path 110 can be moved synchronously with printing of the printing apparatus 190, and whether to convey printed matter to the output tray 111 for printed matter that passed the inspection or the output tray 112 for printed matter that failed the inspection can be switched depending on the inspection results. Also, a GPU (not shown) may be provided in addition to the CPU 101.

The image processing apparatus 100 according to the first example conveys, along the conveyance path 110, printed matter conveyed from the printing apparatus 190, and executes the following inspection processing based on image data of the printed matter read by the image reading device 105. If the result of the inspection processing indicates that the printed matter passed the inspection, the printed matter is conveyed to the output tray 111 for printed matter that passed the inspection. Otherwise, the printed matter is conveyed to the output tray 112 for printed matters that failed the inspection. In this manner, only the printed matter with confirmed print quality can be collected on the output tray 111 as products for delivery.

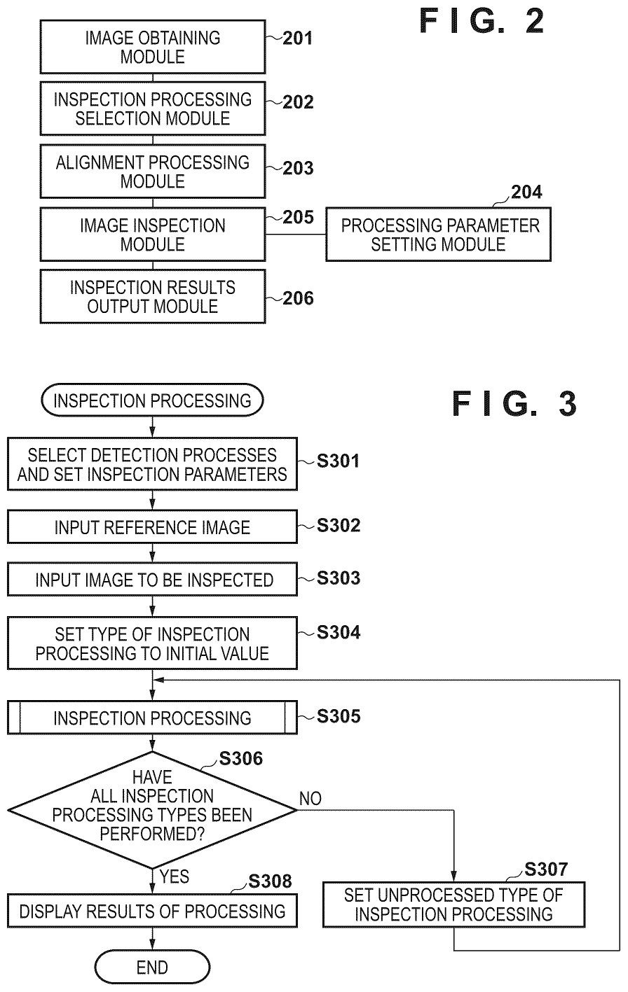

Next, a processing procedure for the inspection processing executed by the image processing apparatus 100 according to the first example will be described with reference to FIGS. 2 and 3.

FIG. 2 is a functional block diagram for describing the functions of the image processing apparatus 100 according to the first example. Note that the functions shown in this block diagram are implemented by the CPU 101 deploying a program stored in the ROM 103 on the RAM 102 and executing the program.

FIG. 3 is a flowchart for describing the inspection processing executed by the image processing apparatus 100 according to the first example. The following processing is implemented, for example, by the CPU 101 deploying a program stored in the ROM 103 on the RAM 102 and executing the program. Also, in the following flowcharts, numbers of steps in the processing is indicated by numerals following the letter S. A processing procedure of the inspection processing, which is overall processing for checking for image defects, will be described with reference to FIGS. 2 and 3. Note that in the example described with reference to FIG. 3, the CPU 101 functions as the functional modules shown in FIG. 2.

In step S301, based on a user input, an inspection processing selection module 202 and a processing parameter setting module 204 select a plurality of types of defect inspection processing to execute and set inspection parameters for the selected types of defect inspection processing. Note that, naturally, it is also possible to select only one type of defect inspection processing.

Here, the inspection processing selection module 202 accepts the selected types of defect inspection processing out of a plurality of types of defect inspection processing via a selection screen (not shown) displayed on the operation panel 108. On the selection screen, for example, more than one types of defects to be inspected can be selected, and the defect inspection processing for detecting the selected defects is selected. The types of defects may include any type of detect, such as dot-shaped defects and linear (streak) defects described in the first example, as well as image unevenness and surface shape detects. If a user selection is not made, predetermined default defect inspection processing may be selected.

Then, the processing parameter setting module 204 registers parameters for executing defect inspection of the types selected by the inspection processing selection module 202. The parameters may include filters appropriate for the defect types, a threshold for determining whether or not a defect is present, and the like. Of these parameters, the threshold is set based on a difference value sent from the printing apparatus 190.

Subsequently, in step S302, an image obtaining module 201 obtains a reference image (reference image data) from the RAM 102 or the main storage unit 104. In this example, the reference image is stored in advance in the RAM 102 or the main storage unit 104.

Subsequently, in step S303, the image obtaining module 201 obtains image data to be inspected (target image to be inspected) by causing the image reading device 105 to read the printed matter to be inspected conveyed from the printing apparatus 190. Note that a configuration may be employed in which the target image to be inspected is read in advance by the image reading device 105, and the target image to be inspected stored in the main storage unit 104 is obtained.

Subsequently, the processing proceeds to step S304, the inspection processing selection module 202 sets, as an initial value, defect inspection processing of the type that is to be executed first out of a plurality of types of defect inspection processing stored in the RAM 102. Here, if there is no priority order in particular for executing the defect inspection processing, the defect inspection processing may be executed in the selected order or any other order.

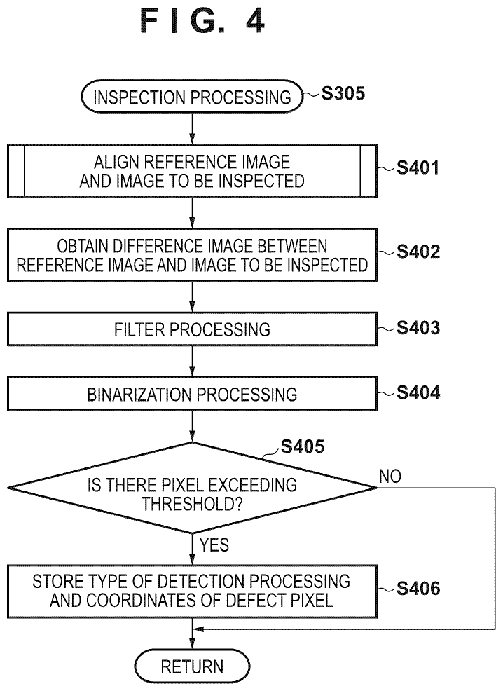

Subsequently, the processing proceeds to step S305, an alignment processing module 203 and an image inspection module 205 align the target image to be inspected with the reference image and execute the defect inspection processing by comparing the aligned images. The details will be described later with reference to FIG. 4.

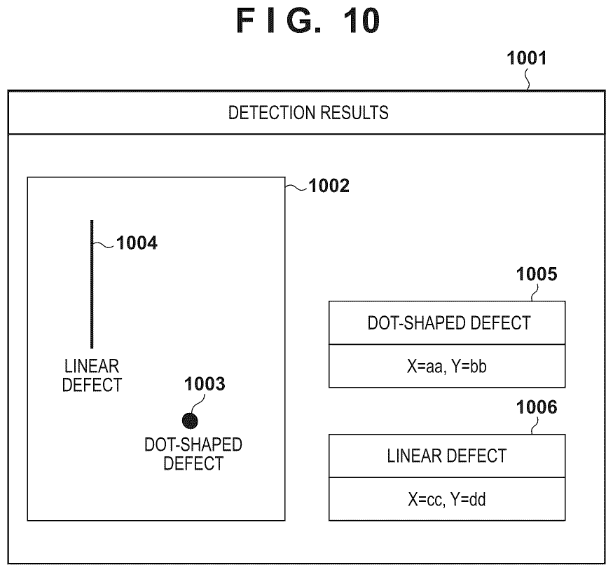

Subsequently, the processing proceeds to step S306, the image inspection module 205 determines whether or not all of the types of defect inspection processing selected in step S301 are complete. If it is determined that all of the selected types of defect inspection processing are complete, the processing proceeds to step S308, and if any incomplete defect inspection processing remains, the processing proceeds to step S307. In step S307, the inspection processing selection module 202 sets the unprocessed type of inspection processing as a target inspection processing type, and the processing proceeds to step S305. Thereafter, the processing in steps S305 to S307 is repeated until all types of defect inspection processing are complete. Meanwhile, if it is determined that all types of defect inspection processing are complete, the processing proceeds to step S308, an inspection results output module 206 generates inspection results, which are displayed on the operation panel 108, and the processing ends. The details of display processing here will be described later with reference to FIG. 10.

Next, a description will be given, with reference to FIG. 4, of a processing procedure of the defect inspection processing executed in step S305 by the alignment processing module 203 and the image inspection module 205 according to the first example.

FIG. 4 is a flowchart for describing the inspection processing in step S305 according to the first example. In the first example, a description is given of an inspection processing method in which a defect in a target image to be inspected is detected by means of comparison with a reference image in which it has been confirmed in advance that no defect is present. The following processing is implemented by the CPU 101 deploying a program stored in the ROM 103 on the RAM 102 and functioning as the functional modules shown in FIG. 2.

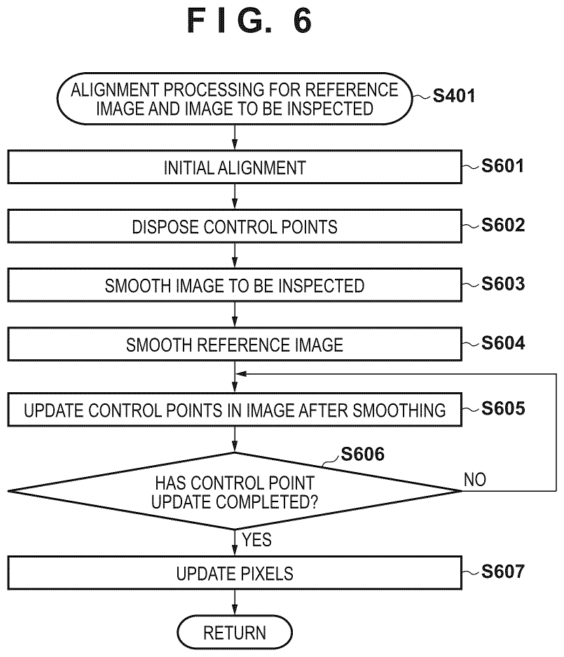

First, in step S401, the alignment processing module 203 aligns the target image to be inspected with the reference image. The details will be described later with reference to FIG. 6. Subsequently, the processing proceeds to step S402, the image inspection module 205 obtains a difference image between the reference image and the target image to be inspected, and the processing proceeds to step S403. Here, a difference image is generated by comparing the reference image with the target image to be inspected pixel by pixel and obtaining difference values of the pixel value (for example, density value for R, G, and B) for each pixel.

Subsequently, the processing proceeds to step S403, the image inspection module 205 executes filter processing for accentuating a specific shape on the difference image obtained in step S402.

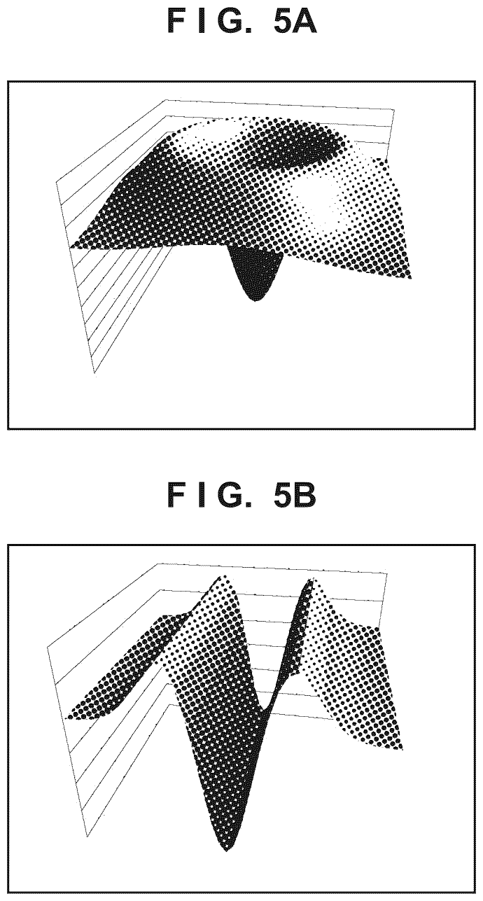

FIGS. 5A and 5B depict views illustrating examples of filters used in the filter processing in step S403 according to the first example.

As examples, FIG. 5A shows a filter for accentuating a dot-shaped defect, and FIG. 5B shows a filter for accentuating a linear defect. These filters may be changed depending on the type of defect inspection processing designated for execution in step S304. For example, if dot-shaped defect detection is designated as defect inspection processing, the filter shown in FIG. 5A is used to execute the filter processing. If linear defect detection is designated as defect inspection processing, the filter shown in FIG. 5B is used to execute the filter processing.

Subsequently, the processing proceeds to step S404, the image inspection module 205 executes binarization processing on the difference image after subjected to accentuation processing through the filter processing (S403) such that difference values greater than or equal to a threshold are set to 1 and difference values less than or equal to the threshold are set to 0. Then, the processing proceeds to step $405, the image inspection module 205 determines whether or not the binarized image includes a pixel with a difference value greater than or equal to the threshold and set to 1. If such a pixel exists in the binarized image, it is determined that a defect pixel is present, and the processing proceeds to step S406. If no such pixel exists in the binarized image, it is determined that no defect section is present, and the processing ends. In step S406, with the presence of a defect section having being determined, the image inspection module 205 stores the type of defect inspection processing with which the defect section was detected and the coordinates of the defect section (defect pixel) in association with each other, and the processing ends. The processing described with reference to the flowchart in FIG. 4 is a subroutine of step S305 and indicates the flow of one type of defect inspection processing. Accordingly, each time the subroutine of step S305 is invoked, the selected type of defect inspection processing is executed and the filter processing (step S403) corresponding to the selected type of defect inspection processing is executed.

In the first example, processing for detecting dot-shaped defects and processing for detecting linear defects have been described as examples of defect inspection processing. However, the present invention is not limited thereto. That is, the present invention may be applied to any processing by which the user can detect a desired defect, and is not limited in terms of the types thereof.

Next, the parameters (inspection parameters) set in step S301 by the processing parameter setting module 204 will be described. In the first example, filter processing (step S403) and binarization processing (step S404) are executed on the obtained difference image, as mentioned above. At this time, reducing the shape of the filter shown in FIG. 5A results in dot-shaped defects that are smaller in size being accentuated and more easily detected. Also, by decreasing the threshold for the binarization processing, smaller differences are set to 1, which is a value greater than or equal to the threshold in the binarization processing, making them detected as defects. In other words, defects with a smaller contrast can be detected by decreasing the threshold. The parameters relating to the size of the filter, the threshold used in detection, and the like are set as the inspection parameters in step S301.

Next, a processing procedure of the alignment processing executed in step S401 by the alignment processing module 203 according to the first example will be described with reference to FIGS. 6, 7A to 7C, 8A to 8D, and 9A to 9C.

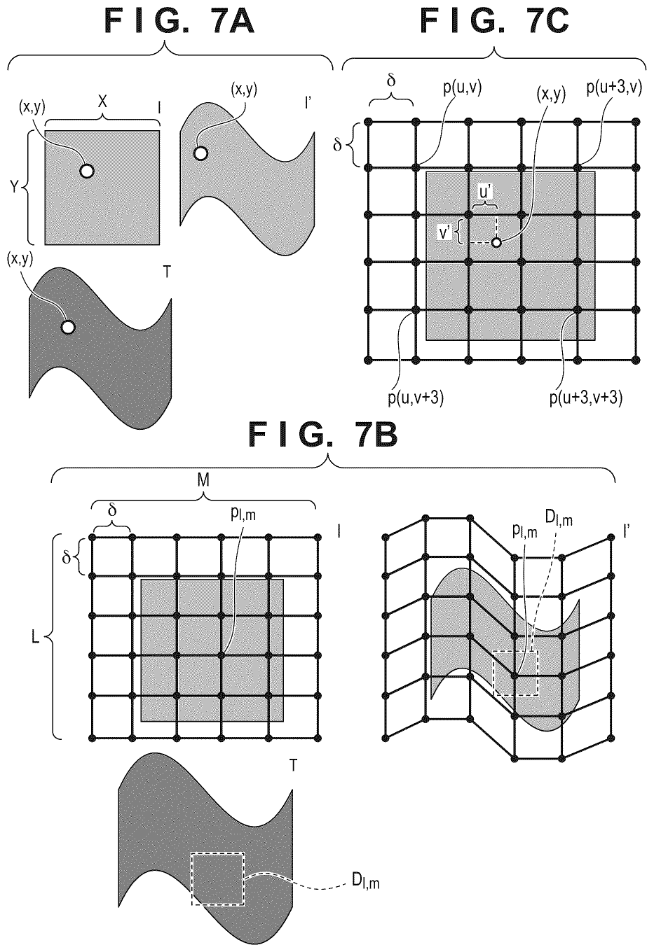

FIGS. 7A to 7C are diagrams for describing processing for aligning a target image I to be inspected with a reference image T according to the first example.

An example will be described in which, in the alignment processing according to the first example, the target image I to be inspected shown in FIG. 7A is aligned with the reference image T, and an aligned target image I′ to be inspected is calculated.

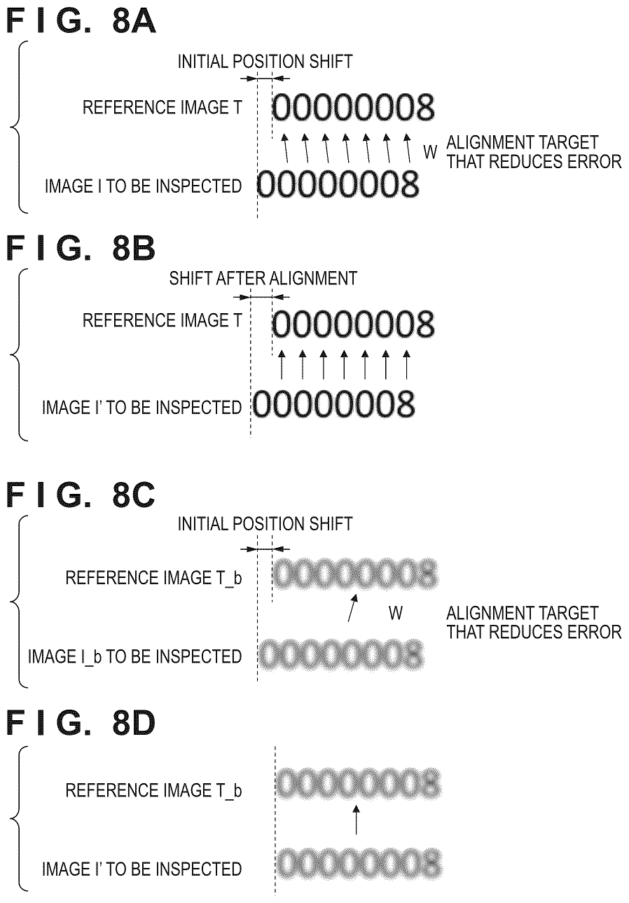

FIGS. 8A to 8D are schematic diagrams for describing the alignment processing according to the first example.

When alignment is performed by moving control points in a direction in which the difference in the pixel values from neighboring pixels decreases, if a similar pattern exists in the vicinity as shown as an example in FIG. 8A, moving the positions of the control points relative to the similar pattern decreases the difference in the pixel values. There are cases where the positions of control points thus moving to positions at which local errors become smaller as shown in FIG. 8A results in inaccurate alignment of the entire images as shown in FIG. 8B. Note that a “similar pattern” refers to, for example, a similar pattern of a character string, a bar code, or the like.

For this reason, image simplifying processing is performed on both the target image I to be inspected and the reference image T, as shown as an example in FIG. 8C, and a simplified target image I_b to be inspected and a simplified reference image T_b are generated. The image simplifying processing is processing for converting a plurality of image element of an image that constitute the aforementioned similar pattern into a lump of image elements, which is obtained by concatenating these image elements, while maintaining the respective positions of the image elements as-is. The image simplifying processing includes, for example, smoothing processing, resolution reduction processing, dilation processing, and the like. In the first example, the case of performing smoothing processing as the image simplifying processing is described.

Then, the alignment processing is performed between the simplified target image I_b to be inspected and the simplified reference image T_b, and moving related information w is calculated. Thus, the alignment processing is performed with a similar and nearby pattern whose elements are concatenated and made into a lump, and the control points are moved to their original positions where errors are minimized, so that accurate alignment can be performed.

FIG. 6 is a flowchart for describing alignment processing for aligning the reference image with the inspection target in step S401 in FIG. 4. The processing described with reference to this flowchart is implemented by the CPU 101 deploying a program stored in the ROM 103 on the RAM 102 and executing the program. Note that I(x, y), T(x, y), I′(x, y), I_b(x, y), and T_b(x, y) represent pixel values at the coordinates (x, y).

In step S601, the alignment processing module 203 performs initial alignment. Here, a typical alignment may be used. For example, one conceivable method is extracting feature points and performing projective transformation such that the sum of Euclidean distances of the feature points is minimized.

Subsequently, the processing proceeds to step S602, the alignment processing module 203 disposes control points. Here, L×M control points are disposed in a grid-like pattern on the target image I to be inspected. At this time, the distance δ between the control points is obtained based on L, M, and the image size. The coordinates of a control point in an 1-th row and an m-th column correspond to P_(l, m) (l=1, . . . , L and m=1, . . . , M). FIG. 7B shows this example.

Subsequently, the processing proceeds to step S603, the alignment processing module 203 performs smoothing processing on the target image I to be inspected and generates a smoothed target image I_b to be inspected. This smoothing processing can be performed using a known method, such as an averaging filter.

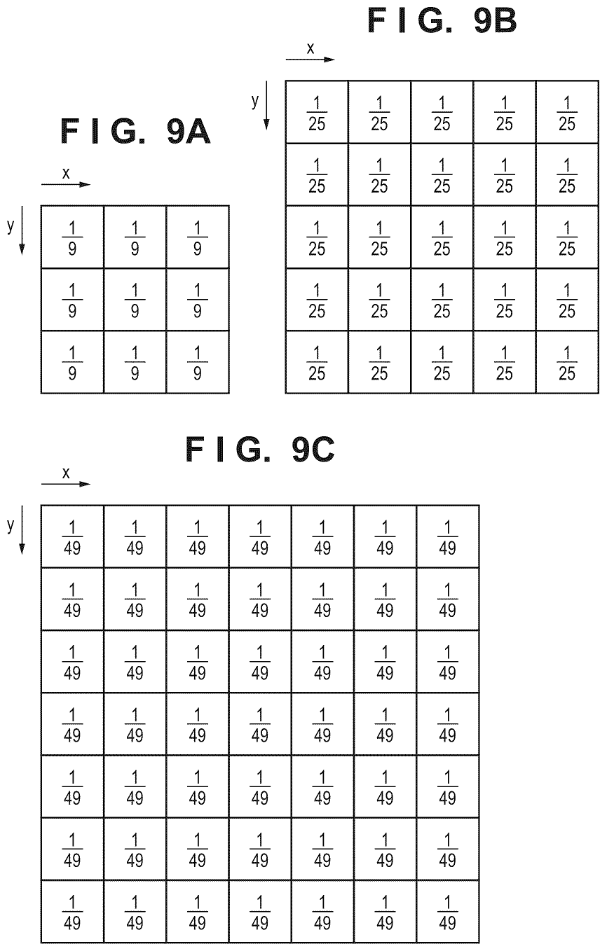

FIGS. 9A to 9C are diagrams showing coefficients of averaging filters according to the first example.

FIG. 9A shows an example of a coefficient for a 3×3 averaging filter, FIG. 9B shows an example of a coefficient for a 5×5 averaging filter, and FIG. 9C shows an example of a coefficient for a 7×7 averaging filter.

The filter size may be an empirically determined fixed size, or may be switched depending on the size of text included in the image. For example, if the resolution of the target image I to be inspected is 150 dpi and the size of text included in the target image is 8 pt (points), an appropriate filter size is 7×7. Instead of performing the smoothing processing on the entire target image I to be inspected, it may also be possible to determine whether similar patterns exist near another by, for example, performing optical character recognition or extraction of pattern areas thereon, and perform the smoothing processing only on the areas where the similar patterns exist. In the first example, the averaging filter is used in the smoothing processing. However, any other known means, such as smoothing with a Gaussian filter, may also be used.

Subsequently, the processing proceeds to step S604, the alignment processing module 203 performs smoothing processing on the reference image T and generates a smoothed reference image T_b. This smoothing processing may be the same as the smoothing processing performed on the target image I to be inspected in step S603. Due to, for example, differences in the modulation transfer function (MTF) between the reference image T and the target image I to be inspected, smoothing processing different from that performed on the target image I to be inspected in step $603 may be performed on the reference image T.

Subsequently, the processing proceeds to step S605, the alignment processing module 203 updates the positions of the control points. The update formula used at this time is represented by Formula (1).

$${p}_{l , m} = {p}_{l , m} + μ \frac{∇ c}{‖ ∇ c ‖} \qquad Formula ( 1 )$$

Note that in Formula (1), μ represents a weighting coefficient and may be a value such as 0.1 or may be changed in accordance with the update speed of the control points, for example. ∇c is a differential value of the sum of squares of the difference in the pixel values between the aligned target image I′ to be inspected and the smoothed reference image T_b at a set D_(l, m) of positions of pixels near a control point P_(l, m) indicated by Formula (2) and shown in FIG. 7B.

$$∇ c = \frac{\partial }{\partial {p}_{l , m}} {\sum }_{{D}_{l , m}} {\vert {I}^{′} ( x , y ) - T ( x , y ) \vert}^{2} \qquad Formula ( 2 )$$

Here, I′(x, y) is expressed by Formula (3) below.

I′(x,y)=I_b(w(x,y)) Formula (3)

Herein, w(x, y) is represented by Formula (4) below, which is a formula for calculating the coordinates in the smoothed target image I_b to be inspected, corresponding to the coordinates (x, y) in the aligned target image I′to be inspected. Bases B_0(t), B_1(t), B_2(t), and B_3(t) in Formula (4) are represented by Formula (5), Formula (6), Formula (7), and Formula (8) below, respectively. Formula (3) below is applied as indicated in FIG. 7C.

u=└x/δ┘−1, v=└y/δ┘−1, u′x/δ−└x/δ┘, v′y/δ−└y/δ┘,

Note that in the first example, grid points used to calculate pixels in the aligned target image I′ to be inspected are 16 points corresponding to p(u, v), p(u+1, v), . . . p(u+3, v+3), but no such limitation is intended. For example, four grid points close to (x, y) in terms of Euclidean distance may alternatively be used.

w(x,y)=Σᵢ₌₀³Σⱼ₌₀³Bᵢ(u′)Bⱼ(v′)p_{u+i,v+j} Formula (4)

B₀(t)=(1−t)³/6 Formula (5)

B₁(t)=(3t³−6t²+4)/6 Formula (6)

B₂(t)=(−3t³+3t²+3t+1)/6 Formula (7)

B₃(t)=t³/6 Formula (8)

Subsequently, the processing proceeds to step S606, the alignment processing module 203 determines whether or not the update of the control points is complete. Whether or not the update of the control points is complete may be determined by calculating a distance d between the aligned target image I′ to be inspected and the reference image T and comparing the distance d with a threshold. Herein, the distance d is expressed by Formula (9) below. When the distance d is less than or equal to than the threshold, the update processing for the control points is complete. On the other hand, if the distance d is less than the threshold, the processing returns to step S605 and the update processing for the control points is continued.

$$d = \frac{1}{X Y} {\sum }_{x = 1}^{X} {\sum }_{y = 1}^{Y} \vert {I}^{′} ( x , y ) - T ( x , y ) \vert \qquad Formula ( 9 )$$

In step S607, the alignment processing module 203 updates pixels of the aligned target image I′to be inspected. The update formula used here is represented by Formula (10).

I′(x,y)=I(w(x,y)) Formula (10)

Here, the pixels of the aligned target image I′ to be inspected can be obtained from the pre-alignment target image I to be inspected using the formula w(x, y) for calculating the coordinates after the alignment processing obtained from the simplified image. As a result, the aligned target image I′ to be inspected that has not been subjected to the image simplifying processing can be obtained. Thus, alignment between the target image I′ to be inspected that has not been subjected to the image simplifying processing and the reference image can be performed. Then, the defect inspection processing can be performed without the influence of a similar and nearby pattern by executing the detection processing using the aligned target image to be inspected and reference image.

In the alignment processing according to the first example, processing for aligning a target image I to be inspected with the reference image T is performed to calculate an aligned target image I′ to be inspected. Conversely, processing for aligning the reference image T with the target image I to be inspected may alternatively be performed, and the direction of alignment is not limited.

Next, the details of the detection results displayed by the inspection results output module 206 in step S308 in FIG. 3 will be described.

FIG. 10 is a diagram showing an example of a screen displaying the inspection results according to the first example.

An overall image 1002 of the target image to be inspected is displayed on a UI screen 1001. In this example, a defect 1003 detected with the filter shown in FIG. 5A is determined as a dot-shaped defect, and text ‘dot-shaped defect’ is displayed together in the vicinity of the defect 1003. A defect 1004 detected with the filter shown in FIG. 5B is determined as a linear defect, and text ‘linear defect’ is displayed together in the vicinity of the defect 1004. Furthermore, the positional coordinates of the detected defects on the image may also be displayed together, as indicated by reference numerals 1005 and 1006.

However, the inspection results display method is not limited to the above method. It need only be recognizable as for which processing has been used, out of the plurality of types of detection processing, to detect the defects by, for example, displaying each type of detection processing with a different color.

As described above, according to the first example, alignment between the target image to be inspected and the reference image can be accurately performed, even in the case of an image that includes a similar and nearby pattern or the like, by performing the alignment processing on the target image to be inspected and the reference image after performing the image simplifying processing thereon. Further, by executing the alignment processing on an image that has not been subjected to the image simplifying processing using the positions of control points obtained from the simplified images, it is possible to perform the defect inspection processing using the target image to be inspected that has not been subjected to the image simplifying processing and the reference image. As a result, the accuracy of defect detection can be increased by improving the alignment accuracy.

### SECOND EXAMPLE

In the above first example, a description has been given of the case of performing the alignment processing after performing the image simplifying processing thereon. In contrast, in the second example, a description is given of the case of performing the alignment processing while gradually reducing the degree of the image simplifying processing performed on the target image to be inspected and the reference image as the number of updates of the control points increases.

There are cases where image features decrease after performing the image simplifying processing, resulting in lower alignment accuracy for fine lines or the like. Therefore, during update processing for the control points, alignment is performed while gradually reducing the degree of the image simplifying processing as the number of updates increases. For example, if smoothing processing is used for the image simplifying processing, the number of updates is used as the condition, and the averaging filter size is gradually reduced as the number of updates increases. This allows the alignment accuracy to be the same as that in a successful case with an original image, while avoiding falling into a local minimum as a result of performing global alignment first. Only differences from the first example will be described below in detail.

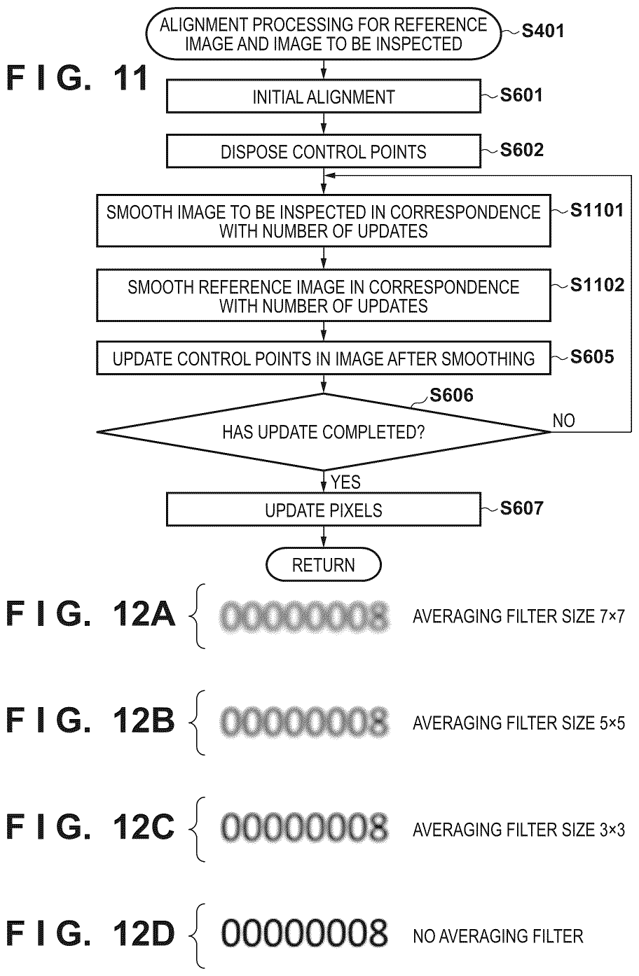

A processing procedure of alignment processing executed in step S401 in FIG. 4 by the alignment processing module 203 according to the second example will be described with reference to FIGS. 11 and 12. In FIG. 11, processing common to the flowchart in FIG. 6 described above are given the same reference numerals, and the description thereof is omitted.

FIG. 11 is a flowchart for describing alignment processing for aligning a reference image with a target image to be inspected in step S401 in FIG. 4 according to the second example.

In step S1101, the alignment processing module 203 performs smoothing processing on the target image I to be inspected in correspondence with the number of updates and generates a smoothed target image I_b to be inspected. This smoothing processing can be performed using a known method, such as an averaging filter.

FIGS. 9A to 9C are diagrams showing coefficients of the averaging filters. FIG. 9A shows an example of a coefficient for a 3×3 averaging filter, FIG. 9B shows an example of a coefficient for a 5×5 averaging filter, and FIG. 9C shows an example of a coefficient for a 7×7 averaging filter. The filter size used is determined in correspondence with the number of updates. For example, the 7×7 averaging filter in FIG. 9C is used for the first to 10th updates, the 5×5 averaging filter in FIG. 9B is used for the 11th to 20th updates, and the 3×3 averaging filter in FIG. 9A for the 21st to 30th updates. The smoothing processing is not performed for the 31st updates onward.

FIGS. 12A to 12D are diagrams showing examples of the target image I_b to be inspected when the filter size used is changed as the number of updates increases in the second example.

As a result, in the early stages of the update, alignment is performed with the smoothing processing being strongly applied. It is therefore possible to prevent the positions of the control points from moving to positions at which errors locally become smaller. The degree of the smoothing processing decreases as the update progresses, and the alignment accuracy improves in detail. Instead of performing the smoothing processing on the entire aligned target image I′ to be inspected, a configuration may also be employed in which it is determined whether a similar pattern exists in the vicinity of the target image I to be inspected by, for example, performing optical character recognition or pattern area extraction thereon, and the smoothing processing is performed only on the areas where these patterns exist. In the second example, the averaging filter is used in the smoothing processing. However, any other known means, such as smoothing using a Gaussian may be used.

Subsequently, the processing proceeds to step S1102, the alignment processing module 203 performs smoothing processing on the reference image T in correspondence with the number of updates and generates a smoothed reference image T_b. This smoothing processing may be the same as the smoothing processing performed on the target image I to be inspected in step S1101. Due to, for example, differences in the modulation transfer function (MTF) between the reference image and the target image to be inspected, smoothing processing different from the smoothing processing performed for the target image I to be inspected in step S1101 may be performed.

As described above, according to the second example, alignment is performed while gradually reducing the degree of the image simplifying processing as the number of updates increases, during the update processing for the control points. This exhibits the effect of preventing misalignment caused due to the positions of the control points moving to positions where errors locally become smaller by performing global alignment first, and increasing the alignment accuracy even in the case of an image with a similar pattern present in the vicinity.

### Variation 1

In the above first and second examples, the case of performing smoothing processing as the image simplifying processing has been described. Meanwhile, resolution reduction processing can also be performed as the image simplifying processing. The resolution reduction processing causes the alignment processing to be performed on an image of a lump of concatenated image elements of a nearby pattern, moves the positions of control points to positions where original errors are minimized, and enables accurate alignment.

Instead of performing the smoothing processing on the target image to be inspected I in step S603 according to the first example, processing for reducing the resolution is performed on the target image I to be inspected to generate the simplified target image I_b to be inspected. For example, if the resolution of the target image I to be inspected is 150 dpi, processing for reducing the resolution of the target image I to be inspected by 50% is performed to generate a target image I_b to be inspected with a resolution of 75 dpi. Any known method, such as nearest neighbor interpolation or linear interpolation, may be used as an algorithm of the resolution lowering processing. In step S604 as well, processing for reducing the resolution can be performed on the reference image T to generate the simplified reference image T_b.

In step S1101 according to the second example, instead of performing smoothing processing on the target image I to be inspected in correspondence with the number of updates of the control points by means of the alignment processing, processing for changing and reducing the resolution as the number of updates increases is performed on the target image I to be inspected. Thus, the simplified target image I_b to be inspected corresponding to the number of updates can be generated. For example, the resolution of the target image I to be inspected is reduced by 25% for the first to 10th updates, the resolution of the target image I to be inspected is reduced by 50% for 11th to 20th updates, and the resolution of the target image I to be inspected is reduced by 75% for 21st to 30th updates. Processing for reducing the resolution is not performed for the 31st update onward. Thus, alignment is performed with the image simplifying processing being strongly applied at the early stage of the update, so that it is possible to suppress misalignment caused due to the positions of the control points moving to positions where errors locally become smaller. The degree of the image simplifying processing decreases as the update progresses, and the alignment accuracy improves in detail. In step S1102 as well, processing for reducing the resolution as the number of updates increases can be performed on the reference image T to generate the simplified reference image T_b.

### Variation 2

In the above first and second examples, the case of performing smoothing processing as the image simplifying processing has been described. Meanwhile, dilation processing can also be performed as the image simplifying processing. The dilation processing causes the alignment processing to be performed on an image of a lump of concatenated image elements of a nearby pattern, moves the positions of control points to positions where original errors are minimized, and enables accurate alignment.

Instead of performing smoothing processing on the target image I to be inspected in step S603 according to the first example, dilation processing is performed on the target image I to be inspected to generate the simplified target image I_b to be inspected. Any known method may be used for the dilation processing. For example, for an image with black text printed on white background, processing for selecting a pixel value closest to black out of a pixel of interest and eight neighboring pixels is performed for all pixels of the target image I to be inspected. The dilation processing may be performed more than once. For example, three times is favorable for an image containing a string of characters with four pixels between characters. In step S604 as well, processing for reducing the resolution can be performed on the reference image T to generate the simplified reference image T_b.

In step S1101 in the second example, instead of performing smoothing processing on the target image I to be inspected in correspondence with the number of updates, the dilation processing corresponding to the number of updates is performed on the target image I to be inspected to generate the simplified target image I_b to be inspected. For example, the dilation processing is performed three times for the first to 10th updates, the dilation processing is performed twice for the 11th to 20th updates, the dilation processing is performed once for the 21st to 30th updates, and the dilation processing is not performed for the 31st update onward. Thus, alignment is performed with the image simplifying processing being strongly applied at the early stage of the update, so that it is possible to suppress misalignment caused due to the positions of control points moving to positions where errors locally become smaller. The degree of the image simplifying processing decreases as the update progresses, and thus the alignment accuracy improves in detail. In step S1102 as well, the simplified reference image T_b can be generated by reducing the number of times of the dilation processing as the number of updates of the reference image T increases.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-186609, filed Nov. 22, 2022, which is hereby incorporated by reference herein in their entirety.

What is claimed is:

1. An inspection apparatus for inspecting a target image to be inspected that is obtained by reading an image formed on a recording medium by a printing apparatus, the inspection apparatus comprising
one or more controllers including one or more processors and one or more memories, the one or more controllers configured to:
execute image simplifying processing for converting a plurality of image elements in image to a lump of image elements in which the plurality of image elements are concatenated, while maintaining positions of the image elements as-is, on a reference image and the target image to be inspected;
perform alignment between the reference image and the target image to be inspected before subjected to the image simplifying processing, using moving related information regarding the alignment between the reference image and the target image to be inspected based on the reference image and the target image to be inspected that have been subjected to the image simplifying processing; and
perform inspection by comparing the aligned reference image with the aligned target image to be inspected.

2. The inspection apparatus according to claim 1,
wherein the one or more controllers are further configured to obtain the moving related information by performing alignment between the reference image and the target image to be inspected that have been subjected to the image simplifying processing.

3. The inspection apparatus according to claim 2,
wherein the one or more controllers are configured to perform the alignment between the reference image and the target image to be inspected that have been subjected to the image simplifying processing by means of non-rigid-body alignment to obtain the moving related information.

4. The inspection apparatus according to claim 2,
wherein, in the image simplifying processing, the one or more controllers are configured to change the image simplifying processing in correspondence with the number of times of the alignment for obtaining the moving related information.

5. The inspection apparatus according to claim 2,
wherein, in the image simplifying processing, the one or more controllers are further configured to reduce a degree of the image simplifying processing as the number of times of the alignment for obtaining the moving related information increases.

6. The inspection apparatus according to claim 5,
wherein, in the image simplifying processing, the one or more controllers are configured to, in a case that the image simplifying processing is smoothing processing, reduce the degree of the image simplifying processing by reducing size of a filter used in the smoothing processing as the number of times of the alignment increases.

7. The inspection apparatus according to claim 5,
wherein, in the image simplifying processing, the one or more controllers are configured to, in a case that the image simplifying processing is processing for reducing resolution, reduce the degree of the image simplifying processing by reducing a degree of reduction of the resolution as the number of times of the alignment increases.

8. The inspection apparatus according to claim 5,
wherein, in the image simplifying processing, the one or more controllers are configured to, in a case that the image simplifying processing is dilation processing, reduce the degree of the image simplifying processing by reducing the number of times that the dilation processing is performed as the number of times of the alignment increases.

9. The inspection apparatus according to claim 1,
wherein the one or more controllers are further configured to set an inspection type and an inspection parameter for the inspection,
wherein the inspection type includes inspection of a dot shape, a linear shape, image unevenness, and a surface shape.

10. The inspection apparatus according to claim 9,
wherein the inspection parameter includes designation of a filter corresponding to the inspection type, and a threshold for determining a defect in the comparison in the inspection.

11. The inspection apparatus according to claim 1,
wherein the one or more controllers are further configured to obtain the target image to be inspected by reading an image formed on the recording medium.

12. The inspection apparatus according to claim 1,
wherein the one or more controllers are further configured to display an inspection result based on the inspection.

13. The inspection apparatus according to claim 12,
wherein, when the inspection result is displayed, the one or more controllers are configured to display whether or not there is a defect corresponding to the inspection type based on the inspection, and in a case where the defect is detected, the one or more controllers are configured to display a position on the image at which the defect is detected.

14. The inspection apparatus according to claim 1,
wherein the image simplifying processing is smoothing processing for smoothing the image.

15. The inspection apparatus according to claim 1,
wherein the image simplifying processing is processing for reducing resolution of the image.

16. The inspection apparatus according to claim 1,
wherein the image simplifying processing is dilation processing for dilating the image.

17. The inspection apparatus according to claim 1,
wherein the plurality of image elements include a nearby and similar character string and bar code in the image.

18. A method of controlling an inspection apparatus for inspecting a target image to be inspected that is obtained by reading an image formed on a recording medium by a printing apparatus, the method comprising:
executing image simplifying processing for converting a plurality of image elements in image to a lump of image elements in which the plurality of image elements are concatenated, while maintaining positions of the image elements as-is, on a reference image and the target image to be inspected;
performing alignment between the reference image and the target image to be inspected before subjected to the image simplifying processing, using moving related information regarding the alignment between the reference image and the target image to be inspected based on the reference image and the target image to be inspected that have been subjected to the image simplifying processing; and
performing inspection by comparing the aligned reference image with the aligned target image to be inspected.

19. A non-transitory computer-readable storage medium storing a program for causing a processor to execute a method of controlling an inspection apparatus for inspecting a target image to be inspected that is obtained by reading an image formed on a recording medium by a printing apparatus, the method comprising:
executing image simplifying processing for converting a plurality of image elements in image to a lump of image elements in which the plurality of image elements are concatenated, while maintaining positions of the image elements as-is, on a reference image and the target image to be inspected;
performing alignment between the reference image and the target image to be inspected before subjected to the image simplifying processing, using moving related information regarding the alignment between the reference image and the target image to be inspected based on the reference image and the target image to be inspected that have been subjected to the image simplifying processing; and
performing inspection by comparing the aligned reference image with the aligned target image to be inspected.
